(19) United States
(12) Patent Application Publication
(10) Pub. No.: US 2025/0156793 A1
(43) Pub. Date: May 15, 2025

(54) INSPECTION LOGISTICS SYSTEM AND INSPECTION LOGISTICS OPTIMIZATION SCHEDULING METHOD

(71) Applicant: Samsung Display Co., LTD., Yongin-si (KR)

(72) Inventors: JONGBEOM PARK, Yongin-si (KR); HOYUN LEE, Yongin-si (KR); JUN-HWAN KANG, Yongin-si (KR)

(21) Appl. No.: 18/780,634

(22) Filed: Jul. 23, 2024

(30) Foreign Application Priority Data
Nov. 13, 2023 (KR) 10-2023-0156425

(51) Int. Cl. G06Q 10/08; G05B 19/418

(52) U.S. Cl. CPC G06Q 10/08; G05B 19/41865; G05B 2219/2621

(57) ABSTRACT

An inspection logistics system includes a plurality of inspection facilities, a linear motion system including a plurality of coils that move inspection objects placed on a carrier to the plurality of inspection facilities, and a controller that controls movement of the carrier. The controller includes a facility status update unit that updates a status of the plurality of inspection facilities, a node recursive search unit that searches for nodes composed of connections between the plurality of coils and updates information existing from a search start point to a reachable inspection facility, and a weight determination unit that selects an inspection facility to which the carrier will move based on a facility status updated by the facility status update unit and information updated by the node recursive search unit.

This application claims priority to Korean Patent Application No. 10-2023-0156425, filed on Nov. 13, 2023, and all the benefits accruing therefrom under 35 U.S.C. § 119, the content of which in its entirety is herein incorporated by reference.

### BACKGROUND

### 1. Technical Field

This invention relates to an inspection logistics system, and more particularly to an inspection logistics system and an inspection logistics optimization scheduling method.

### 2. Description of the Related Art

Hardware that makes up an inspection logistics system is called a linear motion system. The linear motion system is a system that controls logistics by moving a carrier (or mover) carrying a coil (or stator) on which materials (e.g., display devices or display panels) are placed. For efficient distribution of logistics, the inspection logistics system may control logistics by calculating a schedule for the logistics. The calculation result may be given in the form of an ID of the inspection facility. The carrier may be transferred to a corresponding inspection facility through a controller that controls the linear motion system.

### SUMMARY

Embodiments provide an inspection logistics system that may optimize inspection logistics and an inspection logistics optimization scheduling method.

An inspection logistics system, according to an embodiment, includes a plurality of inspection facilities, a linear motion system including a plurality of coils that move an inspection object disposed on a carrier to the plurality of inspection facilities, and a controller that controls movement of the carrier. The controller includes a facility status updating unit that updates a status of the plurality of inspection facilities, a node recursive search unit that searches for nodes composed of connections between the plurality of coils and updates the information existing from a search start point to a reachable inspection facilities, and a weight determination unit that selects an inspection facility to which the carrier will move based on a facility status updated by the facility status update unit and the information updated by the node recursive search unit.

In an embodiment, the facility status update unit may update an operation status of the plurality of inspection facilities, and a remaining time of the inspection process when an inspection object exists in the plurality of inspection facilities.

In an embodiment, the node recursive search unit may determine the status and quantity of all carriers that exist from the search start point to the reachable inspection facility, and may calculate the inter-node movement weight.

In an embodiment, the node recursive search unit may configure a relationship between the plurality of coils as nodes, configure the relationships between nodes as a node list, and search an entire section through a node recursive search.

In an embodiment, the node recursive search part may check a carrier status of a start node in the node list, may obtain a child node list of the start node, may check the carrier status of a node selected in the child node list, and may obtain a child node list of the selected node.

In an embodiment, the node recursive search unit may skip searching for the nodes when there is no inspection object placed on the carrier or when an inspection process of the inspection object is completed.

In an embodiment, the facility status update unit may cause the carrier to stand by in a stopped state without selecting an inspection facility when the plurality of inspection facilities are unavailable.

In an embodiment, the weight determination unit may impose a weight based on the number of carriers existing from the search start point to the reachable inspection facility.

In an embodiment, the weight determination unit may impose a weight based on a remaining inspection time of the inspection object when there is an inspection object being inspected in the plurality of inspection facilities.

In an embodiment, the weight determination unit may terminate a weight calculation when a carrier has stopped on a path from the search starting point to the reachable inspection facility, when the number of carriers moving from the search starting point to the reachable inspection facility and the number of carriers present in the reachable inspection facilities exceeds a specified range, or when the reachable inspection facility is inoperable.

An inspection logistics optimization scheduling method, according to an embodiment, includes updating a status of a plurality of inspection facilities, searching for nodes composed of connections between a plurality of coils that move an inspection object placed on a carrier to the plurality of inspection facilities and updating information existing from a search start point to a reachable inspection facility, and selecting an inspection facility to which the carrier will move based on the updated facility status and the updated information.

In an embodiment, the updating of the status of the plurality of inspection facilities may include updating an operation status of the plurality of inspection facilities, and a remaining inspection process time when an inspection object exists in the plurality of inspection facilities.

In an embodiment, the updating of the information may include determining status and quantity of all carriers existing from the search start point to the reachable inspection facility, and calculating a movement weight between nodes.

In an embodiment, the updating of the information may include configuring a relationship between the plurality of coils as nodes, configuring a relationship between nodes as a node list, and searching an entire section through a recursive search.

In an embodiment, the updating of the information may include checking a carrier status of a start node in the node list, obtaining a child node list of the start node, checking a carrier status of a node selected in the child node list, and obtaining a child node list of the selected node.

In an embodiment, the inspection logistics optimization scheduling method may include skipping searching for the nodes when there is no inspection object placed on the carrier or when an inspection process of the inspection object is completed.

In an embodiment, the inspection logistics optimization scheduling method may include causing the carrier to stand by in a stopped state without selecting an inspection facility when the plurality of inspection facilities are unavailable.

In an embodiment, the selecting of the inspection facility may include imposing a weight based on the number of carriers existing from the search start point to the reachable inspection facility.

In an embodiment, the selecting of the inspection facility may include imposing a weight based on a remaining inspection time of the inspection object when there is an inspection object being inspected in the plurality of inspection facilities.

In an embodiment, the inspection logistics optimization scheduling method may include terminating a weighting calculation when a carrier has stopped on a path from the search starting point to the reachable inspection facility, when the number of carriers moving from the search starting point to the reachable inspection facility and the number of carriers present in the reachable inspection facility exceed a specified range, or when the reachable inspection facility is inoperable.

According to embodiments, an inspection logistics system capable of optimally scheduling inspection logistics and an inspection logistics optimization scheduling method may be provided.

Additionally, according to embodiments, there are advantageous effects that may be recognized throughout the specification.

### BRIEF DESCRIPTION OF THE DRAWINGS

FIG. 1 is a schematic block diagram that shows an inspection logistics system, according to an embodiment.

FIG. 2 is a schematic block diagram that shows a node search configuration in an inspection logistics system, according to an embodiment.

FIG. 3 is a block diagram that shows node list configuration logic, according to an embodiment.

FIG. 4 is a block diagram showing the configuration of a controller in an inspection logistics system, according to an embodiment.

FIG. 5 is a block diagram that shows facility status update logic, according to an embodiment.

FIG. 6 is a flow diagram that shows node recursive search logic, according to an embodiment.

FIG. 7 is a flow diagram that shows weight determination logic, according to an embodiment.

FIG. 8A is a schematic block diagram that illustrates a recursive search, according to an embodiment.

FIG. 8B is a schematic block diagram that illustrates a recursive search, according to an embodiment.

FIG. 8C is a schematic block diagram that illustrates a recursive search, according to an embodiment.

FIG. 9 is a schematic block diagram that illustrates a calculation of an inspection logistics optimization schedule, according to an embodiment.

### DETAILED DESCRIPTION

With reference to the attached drawings, the embodiments will be described in detail so that those skilled in the art can easily implement the invention.

When a part of a layer, membrane, region, or plate, is said to be “above” or “on” another part, this includes not only being “directly on” another component, but also having another component in between. Conversely, when a composition is said to be “right above” another composition, it means that there is no other composition in between.

Throughout the specification, it means that a certain part may further include other components, unless there is a statement to the contrary that it “includes” a certain component.

Throughout the specification, “connected” does not mean only when two or more components are directly connected, but when two or more components are indirectly connected through other components, when they are physically connected, or when they are electrically connected, it may include embodiments where each part, which may be referred to by a different name depending on location or function, but is substantially integrated, is connected to another.

In the drawings, the symbols “X”, “Y”, and “Z” are used to indicate directions, where “X” is a first direction, “Y” is a second direction perpendicular to the first direction, and “Z” is a third direction perpendicular to the first and second directions.

In addition, the size and thickness of each component shown in the drawings are arbitrarily shown for convenience of explanation, so the invention is not necessarily limited to that which is shown.

In the drawings, the thicknesses are enlarged to clearly express various layers and areas.

And in the drawings, for convenience of explanation, the thicknesses of some layers and regions are exaggerated.

Additionally, when a part of a layer, membrane, region, or plate is said to be “above” or “on” another part, this includes not only cases where it is “directly above” another part, but also cases where there is another part in between. Conversely, when a part is said to be “right on top” of another part, it means that there is no other part in between.

In addition, being “above” or “on” a reference part means being located above or below the reference part, and does not necessarily mean being located “above” or “on” it in the direction opposite to gravity.

In addition, throughout the specification, when a part is said to “include” a certain component, this means that it may further include other components rather than excluding other components, unless specifically stated to the contrary.

In addition, throughout the specification, when reference is made to “on a plane,” this means when the target portion is viewed from above, and when reference is made to “in a cross-section,” this means when a cross-section of the target portion is cut vertically and viewed from the side.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. In addition, unless explicitly described to the contrary, the word “comprise,” and variations such as “comprises” or “comprising,” will be understood to imply the inclusion of stated elements but not the exclusion of any other elements.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the invention.

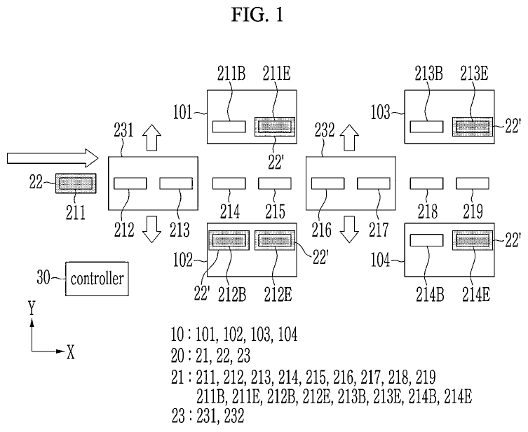

FIG. 1 schematically shows an inspection logistics system, according to an embodiment.

In an embodiment, the inspection logistics system may include inspection facility 10, a linear motion system 20, and a controller 30.

In an embodiment, the inspection facility 10 (hereinafter also referred to as “EQP”) is a facility that performs an inspection process and may be provided in plural. For example, the inspection facility 10 may include first to fourth inspection facilities 101-104, respectively. The first to fourth inspection facilities 101-104, respectively, may be arranged to be spaced apart from each other. For example, the first facility 101 and the second inspection facility 102 may be spaced apart from each other in the second direction Y, and the first inspection facility 101 and the third inspection facility 103 may be spaced apart from each other in the first direction X. The third inspection facility 103 and the fourth inspection facility 104 may be spaced apart from each other in the second direction Y, and the fourth inspection facility 104 and the second inspection facility 102 may be spaced apart from each other in the first direction X.

In an embodiment, the inspection facilities 101-104 may perform the same type of inspection. For example, the inspection facilities 101-104 may control lighting of a display device, and inspect characteristics of the display device, the image displayed on the display device, the color of the image displayed on the display device, the touch sensor of the display device, or the appearance of the display device. At least one of the inspection facilities 101-104 may perform a different type of inspection than the others. The inspection facilities 101-104 may each have information about their own operation status. Although four inspection facilities 101-104 are illustrated, more or fewer inspection facilities 10 may be placed.

In an embodiment, the linear motion system 20 may move an inspection object or an object. The inspection object may be a display device or a display panel. The display device or the display panel may be an electronic device that includes a display screen that displays images. The linear motion system 20 may include a coil 21, a carrier 22, and a ferry 23.

In an embodiment, the coil 21 may move the carrier 22 disposed thereon, and may be provided in plural. For example, the coil 21 may include first to ninth coils 211-219, respectively, arranged along the first direction X. The coils 211-219 may be arranged along the first direction X. The coils 211-219 may move the carrier 22 in the first direction X. For example, the carrier 22 mounted on the first coil 211 may move to the second coil 212, and the carrier 22 mounted on the second coil 212 may move to the third coil 213. Although nine coils 211-219 are illustrated, the number of coils 21 may vary depending on the number of inspection facilities 10, etc.

In an embodiment, the coil 21 may include buffer coils 211B-214B and facility coils 211E-214E located in the inspection facility 10. Specifically, the coil 21 includes a first buffer coil 211B and a first facility coil 211E located in the first inspection facility 101, a second buffer coil 212B and a second inspection coil 212E located in the second inspection facility 102, a third buffer coil 213B and a third inspection coil 213E located in the third inspection facility 103, and a fourth buffer coil 214B and a fourth inspection coil 214E located in the fourth inspection facility 104. The buffer coils 211B-214B may be coils that exist as waiting sections before entering the inspection process, and the facility coils 211E-214E may be coils used during the inspection process. The buffer coils 211B-214B and the inspection coils 211E-214E may move the carrier 22 in the first direction X like the coils 211-219.

In an embodiment, the carriers 22 and 22′ may transport the inspection object, and may be provided in plural. The carrier 22 may move on the coil 21 in the first direction X. Six carriers 22 and 22′ are shown, but the number of carriers 22 and 22′ included in the inspection logistics system may vary depending on the number of inspection facilities 10, etc.

In an embodiment, the ferry 23 may move the coil 21 in the second direction Y. Ferries 23 may be provided in plural. For example, the ferry 23 may include the first ferry 231 located before the first and second inspection facilities 101 and 102, and the second ferry 232 located before the third and fourth inspection facilities 103 and 104. The second and third coils 212 and 213 may be located above the first ferry 231, and the sixth and seventh coils 216 and 217 may be located above the second ferry 232. As the first ferry 231 moves the second and third coils 212 and 213 in the second direction Y, the second and third coils 212 and 213 may be aligned with the first buffer coil 211B and the first facility coil 211E in the first direction X, or they may be aligned with the fourth and fifth coils 214 and 215 in the first direction X, or they may be aligned with the second buffer coil 212B and the second facility coil 212E in the first direction X. As the second ferry 232 moves the sixth and seventh coils 216 and 217 in the second direction Y, the sixth and seventh coils 216 and 217 may be aligned with the third buffer coil 213B and the third facility coil 213E in the first direction X, or they may be aligned with the eighth and ninth coils 218 and 219 in the first direction X, or they may be aligned with the fourth buffer coil 214B and the fourth facility coil 214E in the first direction X. For example, when the second and third coils 212 and 213 are aligned with the first buffer coil 211B and the first facility coil 211E in the first direction X, the carrier mounted on the third coil 213 (22) may move to the first buffer coil 211B.

In an embodiment, the controller 30 may control the overall operation of the inspection logistics system. The controller may control the movement of the carriers 22 and 22′. For example, the controller 30 may control the carriers 22 and 22′ on which the inspection object is placed to move to a specific inspection facility 10 through the coil 21. The controller 30 may be a computer including a processor, memory, input/output devices, etc.

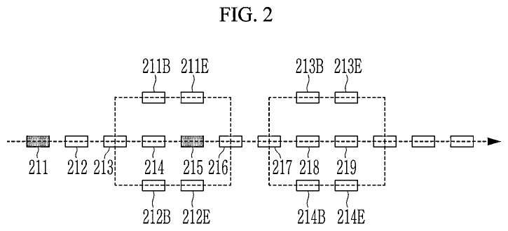

FIG. 2 is a block diagram showing a node search configuration in an inspection logistics system, according to an embodiment.

In an embodiment, FIG. 2 shows the coils 21 shown in FIG. 1 as nodes. Each node is depicted as a square. The nodes may correspond to the positions of the coil 21 shown in FIG. 1, and the dotted lines may correspond to possible movement paths of the carrier 22 shown in FIG. 1. For efficient distribution of logistics, the schedule for logistics may be configured using a node search algorithm. The node search algorithm may include configuring relationships between coils as nodes and configuring logic using a score weight method. Organizing the relationship between coils as nodes may include configuring the relationship between nodes into a linked list and searching the entire section through a recursive search (i.e., a depth-first search). Constructing the logic of the score weighting method may include searching the entire section and adding weights for each case to obtain the location with the lowest score. By allowing the user to customize the configuration of weights and nodes as desired, a program independent function may be implemented.

In an embodiment, the configuration of nodes may be written as a node table. The node table may describe the connection relationship between any coil to coils at the next location. For example, the node table may assign an ID to each coil and record a next ID that may be reached from that ID. The relationship between this ID and the next ID can be described as a FROM and TO relationship. By setting availability, the end point of a node search may be set. For example, it may be set 1 if a node is available, and 0 if it is not available. By adding a speed or distance item, a distance weight between coils may be entered into the node table. The node table may be stored in the memory of the controller 30.

In an embodiment, the configuration of weights may be written as a weight table. An arrival weight from any coil to the inspection facility may be set and recorded in the weight table. The coil ID in the weight table may be the same as the coil ID in the node table, and a schedule priority to a specific inspection facility may be adjusted by setting the weight. The weight table may be stored in the memory of the controller 30.

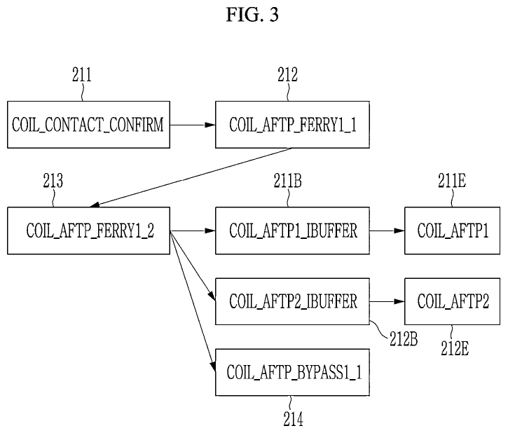

FIG. 3 a block diagram showing node list configuration logic, according to an embodiment.

In an embodiment and referring to FIG. 3, a link between coils may be configured using the contents described in the node table. In FIG. 3, the term written within each block is the coil ID. For example, COIL_CONTACT_CONFIRM is the ID of the first coil 211, COIL_AFTP_FERRY1_1 is the ID of the second coil 212, COIL_AFTP_FERRY1_2 is the ID of the third coil 213, COIL_AFTP1_IBUFFER is the ID of the first buffer coil 211B, COIL_AFTP2_IBUFFER is the ID of the second buffer coil 212B, COIL_AFTP_BYPASS1_1 is the ID of the fourth coil 214, COIL_AFTP1 is the ID of the first facility coil 211E, and COIL_AFTP2 is the ID of the second facility coil 212E. The coil ID may be set in various ways by the user. The node list may be constructed by creating a list of all coils based on the coil ID written in the FROM item in the node table and connecting the coil ID written in the TO item in the node table to the child set of the coil list. The configuration may be a cyclical loop type or an acyclic type.

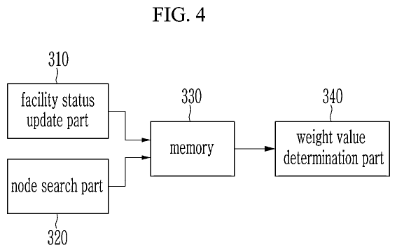

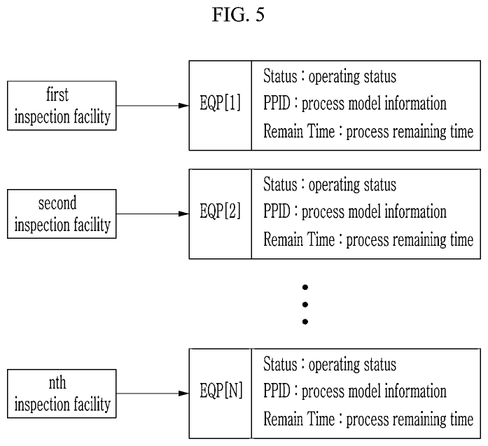

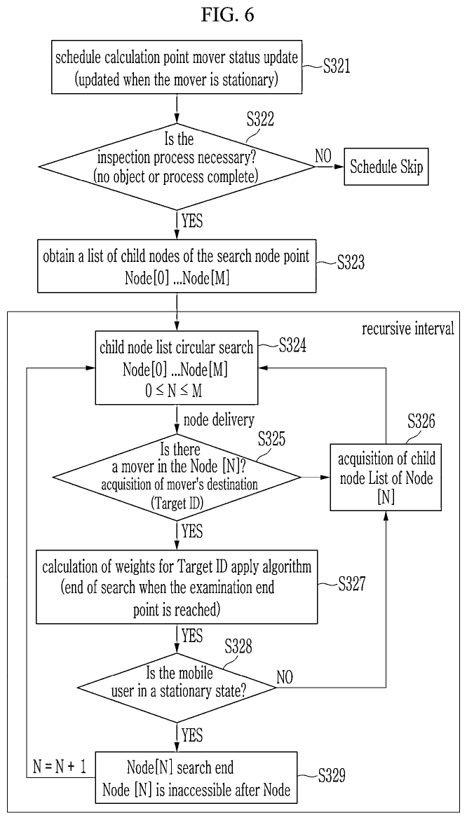

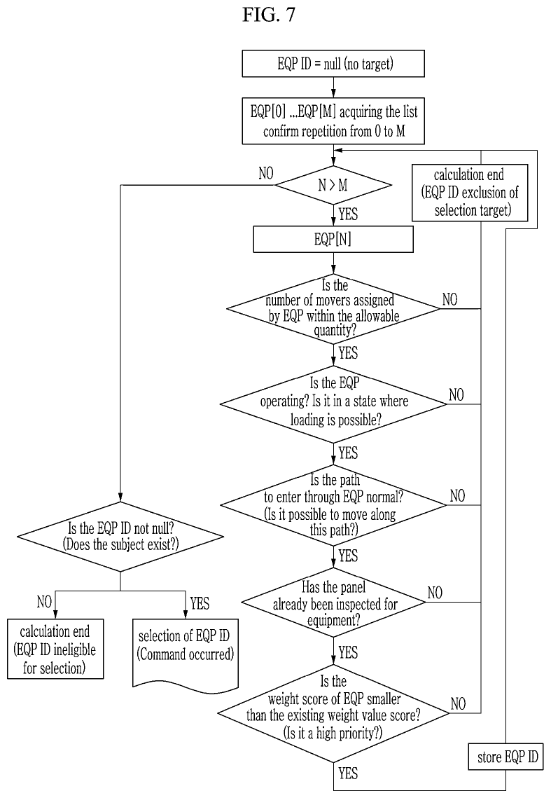

FIG. 4 is a block diagram showing the configuration of a controller in an inspection logistics system, according to an embodiment. FIG. 5 is a block diagram illustrating facility status update logic, according to an embodiment, FIG. 6 is a flow diagram illustrating node recursive search logic, according to an embodiment, and FIG. 7 is a flow diagram illustrating weight determination logic, according to an embodiment.

In an embodiment and referring to FIG. 4, the controller 30 may traverse the entire information of the inspection facility and all the nodes, record the values detected from the traversed nodes in the score table of the inspection facility, and select the inspection facility ID that received the lowest score among the available inspection facility. To this end, the controller 30 may include a facility status update unit 310, a node recursive search unit 320, a memory 330, and a weight determination unit 340.

In an embodiment and referring FIGS. 4 and 5, the facility status update unit 310 may update facility status, such as whether the inspection facility is in operation, production model information (PPID), and inspection process remaining time (remain time). Facility status update may be a process of securing data on the availability status of the facility independently of the weight score. Facility information is matched 1:1 with inspection facility, allowing information on the current status of each inspection facility to be updated. The updated facility status may be stored in the memory 330.

In an embodiment and referring to FIGS. 4 and 6, the node recursive search unit 320 may determine the status and number of all coils that exist from the schedule start point (search start point) to all reachable inspection facilities, and calculate the corresponding number information and the movement weight information between nodes. This may be a process to update the entire information existing from the start of the search to the final inspection facility. The updated information may include the number of carriers heading to or arriving at the inspection facility, the presence of carriers stopped on the road toward the inspection facility, etc. The update order may include checking the carrier status of the start node, obtaining the list of child nodes of the node whose status has been checked, and repeating the steps of selecting an item from the obtained child node list, checking the carrier status of the selected node, and obtaining the child node list. Information on the number of carriers and movement weight information between nodes obtained by the node recursive search unit 320 may be stored in the memory 330.

In an embodiment, to explain the node search algorithm in more detail, the carrier status may be updated at the schedule calculation point S321. The status of the carrier may include the presence or absence of an inspection object on the carrier and whether the inspection process of the inspection object on the carrier has been completed. The carrier state may be updated when the carrier is at rest. After checking the status of the carrier, it may be determined whether the inspection process is necessary S322. For example, if there is no inspection object placed on the carrier or it is determined that the inspection process is not necessary because the inspection process of the inspection object is completed, the schedule may be skipped. If it is determined that it is necessary to proceed with the inspection process, a list of child nodes of the search node starting point may be obtained S323. The child node list may be written, for example, as Node[0], . . . , Node[M]. Next, an item (Node[N]) may be selected from the child node list S325, and it may be determined whether there is a carrier in the selected item (Node[N]) S326. If it is determined that there is no carrier, the child node list of the selected item (Node[N]) may be obtained S326, and the child node list may be searched S324. If it is determined that there is a carrier, the carrier's destination (target inspection facility ID) may be obtained, and a weight determination algorithm for the target inspection facility ID may be applied S327. The weight determination algorithm will be described later with reference to FIG. 7. Next, it is determined whether the carrier in the selection item (Node[N]) is in a stationary state (S328), and if the carrier is not in a stationary state, a child node list of the selection item (Node[N]) S236 may be obtained, and the child node list may be searched (S324). If the carrier is in a stationary state, it may terminate the search of the selected item (Node[N]) S329, and start the cyclic search of the next item (Node[N+1]). This circular search of the child node list may end when the selected node reaches an inspection facility or inspection termination point. Search termination conditions may be specified as availability settings in the node table.

In an embodiment and referring to FIG. 4 and FIG. 7, the weight determination unit 340 determines the priority by adding the facility status information obtained by the facility status update unit 310 and the node search result obtained by the node recursive search unit 320.

That is, in an embodiment, the weight determination unit 340 ultimately selects the inspection facility ID of the most efficient point based on the information collected through the facility status update unit 310 and the node recursive search unit 320 and stored in the memory 330. For example, in an embodiment, the inspection facility ID of the most efficient branch may be the inspection facility ID with the lowest score. If all inspection facilities are unavailable, it may wait in a stopped state without selecting the inspection facility ID.

Referring to FIG. 7, the weight determination algorithm may include checking the conditions of available inspection facilities from the calculation starting point, according to an embodiment.

For this purpose, in an embodiment, a list of inspection facilities or a list of inspection facility IDs (EQP[0], . . . , EQP[M]) may be obtained. By selecting an item from the inspection facility ID list, the weight may be calculated while checking several conditions. If the number of carriers assigned to the inspection facility (e.g., EQP[N]) is within the allowable number, if the EQP is in operation (if loading is possible), and if the path entering the inspection facility is normal (if it is possible to move to the corresponding route), if the inspection object is an inspection facility that has already been inspected, and if the weight score of the inspection facility is lower than the weight score of the inspection facility already calculated (if the priority is high), after saving the inspection facility ID, the procedure to check conditions for the next inspection facility may be performed. If the movement of the carrier is impossible due to the stoppage of another carrier on the path to the inspection facility, or if the number (score) of carriers moving to the inspection facility and those present at the inspection facility is more than the specified range, or if the inspection facility is inoperable, the inspection facility cannot perform the inspection, and therefore, the calculation may be terminated and the inspection facility may be excluded from the selection target.

Meanwhile, in an embodiment, when the condition check is completed for all EQP IDs in the acquired inspection facility list (N>M), it may be determined whether the EQP ID is null, that is, whether the target exists. If the target exists, the EQP ID may be selected and a schedule command may be generated. If the target does not exist, the calculation may end and EQP ID selection may not be possible. In this case, the carrier may maintain the current position without moving.

An embodiment of the weight configuration is as follows. If there is a migrant moving to the inspection facility on the node path moving to the inspection facility (EQP[N]), a high weight (e.g., +1000 points) may be assigned. Even if there is a carrier in the relevant inspection facility, a high weight (e.g., +1000 points) may be assigned. Since the movement time of the carrier between nodes may be short compared to the inspection time, the movement weight between nodes may be given as less than actual amount. For example, the weight of movement between nodes may be arbitrarily set by the user, such as +1 point, and the weight of movement may be based on distance and speed, and the size of the weight may be determined by the user as needed. A weighted +R point may be assigned to the EQP[N] points. In other words, the user may interfere with the priority by selecting a separate weight for each inspection facility. A weight +T point may also be assigned to the remaining inspection time of EQP[N]. For example, in an embodiment, the remaining inspection time may be determined by subtracting it from the standard inspection time in real time.

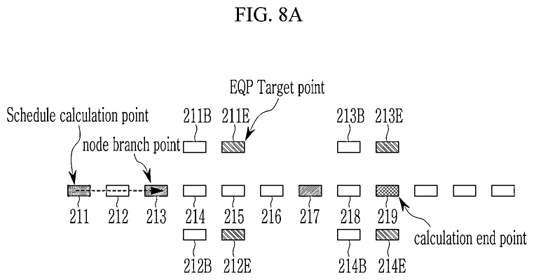

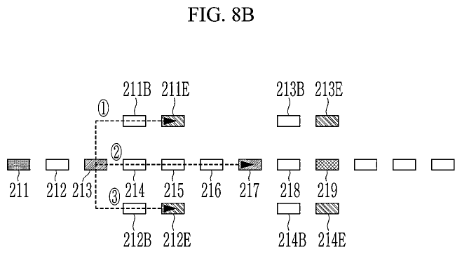

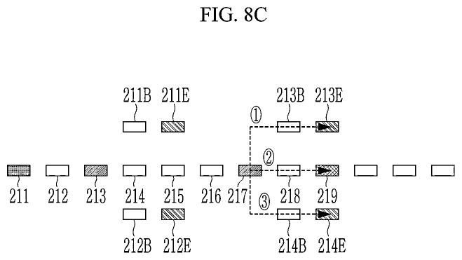

FIG. 8A, FIG. 8B, and FIG. 8C are block diagrams that illustrate recursive search, according to an embodiment.

In an embodiment and referring to FIG. 8A, a sequential search may be performed from the calculation start node to the next node. When a node branching point is reached, the next node may branch in three directions.

In an embodiment and referring to FIG. 8B, searching in the order shown may be started. The 1) direction search may be ended at the destination point, and the 2 direction search may be started and may proceed with sequential search to the next node. When a node branching point is reached, the next node may branch in three directions.

In an embodiment and referring to FIG. 8C, searching in the order shown may be started. The 1) direction search may be ended at the destination point, and the 2 direction search may be ended and the sequential search to the next node may follow. Once a node branch point is reached, the next node may branch in three directions and start searching in the indicated order. When the 1) direction, 2 direction, and 33 direction searches in FIG. 8C are completed, the 2 direction search in 8B is completed. Then, the 3 direction search in FIG. 8B may be completed.

In an embodiment, information acquired during the search may include information on the carrier of the node, for example, presence/absence of the carrier, movement/stop of the carrier, and movement target point of the carrier. It is possible to determine whether the route may be moved through the presence/absence of the carrier and the moving/stationary status. By confirming the movement target point of the carrier, the number of carriers moving or arriving at each inspection facility may be secured, and weights may be applied to each EQP. The information may be stored in a memory that collects weight information.

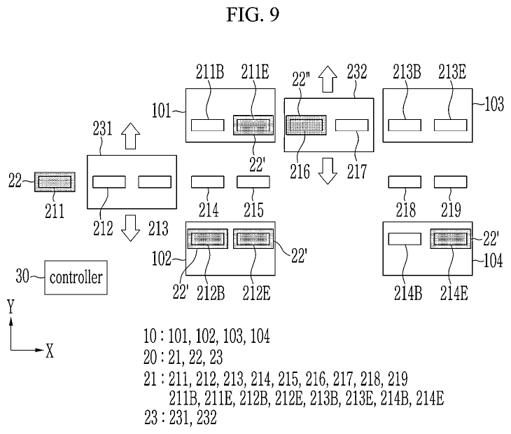

FIG. 9 is a block diagram illustrating a calculation of an inspection logistics optimization schedule, according to an embodiment.

In an embodiment and referring to FIG. 9, the calculation starts from the first coil 211, and it may be confirmed that there are no abnormalities in the nodes with the second coil 212 and the third coil 213. The node may then branch at the third coil 213, and the search may end with the third coil 213, the first buffer coil 211B, and the first facility coil 211E. The first inspection facility 101 may be determined to be accessible. Since there is one carrier 22′ in the first inspection facility 101, a carrier weight of +1000 points may be added to the first inspection facility 101. When the remaining inspection process time of the inspection object placed on the carrier 22′ on the first facility coil 211E is 40 seconds, a remaining time weight of +40 points may be added to the first inspection facility 101.

Next, in an embodiment, the search may proceed from the third coil 213, where the node branches, to the fourth coil 214, the fifth coil 215, the sixth coil 216, and the seventh coil 217. When the carrier 22″ is in a stopped state in the sixth coil 216, access to the nodes of the third inspection facility 103 and the fourth inspection facility 104 may be impossible. If the movement target point of the carrier 22″ on the sixth coil 216 is confirmed by the third inspection facility 103, a carrier weight of +1000 points may be added to the third inspection facility 103.

In an embodiment, the node may branch from the seventh coil 217, and the search may proceed to the seventh coil 217, the third buffer coil 213B, and the third facility coil 213E. Since there is no carrier in the third inspection facility 103, a carrier weight of 0 point may be added to the third inspection facility 103, and a remaining time weight of 0 point may be added to the third inspection facility 103.

In an embodiment, the search may proceed from the seventh coil 217, where the node branches, to the eighth coil 218 and the ninth coil 219. Since the ninth coil 219 is the last coil, the search may end at the ninth coil 219. That is, the ninth coil 219 may be the search end position.

Next, in an embodiment, the search may proceed from the seventh coil 217 to the fourth buffer coil 214B and the fourth facility coil 214E. Since the carrier 22′ exists on the fourth facility coil 214E, a carrier weight of +1000 points may be added to the fourth facility coil 214E.

In an embodiment, if the remaining time for the inspection process of the inspection object placed on the carrier 22′ on the fourth facility coil 214E is 3 seconds, a remaining time weight of 3 points may be added to the fourth inspection facility 104.

Next, in an embodiment, the search may proceed from the third coil 213 to the second buffer coil 212B and the second facility coil 212E, and the search may end at the second facility coil 212E. If there are two carriers 22′ in the second inspection facility 102, a carrier weight of +2000 points may be added to the second inspection facility 102. If the remaining inspection process time of the inspection object placed on the carrier 22′ on the second facility coil 212E is 10 seconds, a remaining time weight of +10 points may be added to the second inspection facility 102.

In an embodiment, the status and weight of each inspection facility are summarized in Table 1 below according to the calculation results described above. The movement weight between carriers was added as +1 point.

TABLE 1

| | First | Second | Third | fourth |
|---|---|---|---|---|
| | EQP | EQP | EQP | EQP |
| Carrier score | +1000 | +2000 | +1000 | +1000 |
| Remaining time | +40 | +10 | +0 | +3 |
| Coil move weight value | +4 | +4 | +8 | +8 |
| Facility status | normal | normal | normal | normal |
| Node approach | possible | possible | impossible | impossible |
| Below carrier score max | normal | abnormal | abnormal | normal |
| Total | 1019 | 2014 | 1008 | 1011 |

In an embodiment, as a result of the calculation, the score priority (the lower the score, the higher the priority) is the third inspection facility 103, the fourth inspection facility 104, the first inspection facility 101, and the second inspection facility 102. However, the third inspection facility 103 and the fourth inspection facility 104 may be excluded because the node is inaccessible, and the second inspection facility 102 may be excluded because the number of carriers is the maximum. Accordingly, the schedule target of the carrier may be the first inspection facility 101.

As in the above-described embodiment, by applying a scheduling algorithm to a linear motion system, efficient schedule management of logistics may be possible. For example, unnecessary movement operations do not occur, and the possibility of logistics congestion due to moving operations first may be reduced. In addition, in an embodiment, it is possible to reflect the status of the logistics in motion, thereby minimizing the waiting time for input logistics. Additionally, real-time update of schedule commands may be possible. For example, by confirming the actual movement destination of logistics, it may be possible to immediately re-reflect orders in response to user intervention. Additionally, the weight for the schedule may be defined by the user. For example, the priority of EQP selection by the user may be reflected by setting individual weights for node search operations and final destinations. Additionally, in an embodiment, it is possible to share scheduling logic for various node types. The logic for most types of logistics may be shared, and the entire system may be searched according to the configuration of the node table.

Although embodiments have been described in detail above, the scope of the invention is not limited thereto, and various modifications and improvements made by those skilled in the art using the basic concepts of the invention. Therefore, the scope of the invention is not limited to the contents described in the detailed description of the specification. Moreover, the embodiments or parts of the embodiments may be combined in whole or in part without departing from the scope of the invention.

What is claimed is:

1. An inspection logistics system, comprising:
a plurality of inspection facilities;
a linear motion system including a plurality of coils that move an inspection object disposed on a carrier to the plurality of inspection facilities; and
a controller that controls movement of the carrier,
wherein the controller comprises:
a facility status updating unit that updates a status of the plurality of inspection facilities;
a node recursive search unit that searches for nodes composed of connections between the plurality of coils, and updates information obtained from a search start point to a reachable inspection facility; and
a weight determination unit that selects an inspection facility to which the carrier will move based on a facility status updated by the facility status update unit and information updated by the node recursive search unit.

2. The inspection logistics system of claim 1, wherein
the facility status update unit updates an operation status of the plurality of inspection facilities, and a remaining inspection process time when an inspection object is disposed in the plurality of inspection facilities.

3. The inspection logistics system of claim 1, wherein
the node recursive search unit determines status and quantity of all carriers disposed between the search start point and the reachable inspection facility, and
calculates a movement weight between the nodes.

4. The inspection logistics system of claim 3, wherein
the node recursive search unit configures a relationship between the plurality of coils as the nodes, configures a relationship between the nodes as a node list, and searches an entire section through a recursive search.

5. The inspection logistics system of claim 4, wherein
the node recursive search unit checks a carrier status of a starting node in the node list, obtains a child node list of the starting node, checks a carrier status of a selected node selected in the child node list, and obtains a child node list of the selected node.

6. The inspection logistics system of claim 1, wherein
the node recursive search unit skips searching for the nodes when there is no inspection object disposed on the carrier or when an inspection process of the inspection object is completed.

7. The inspection logistics system of claim 1, wherein
the facility status update unit causes the carrier to stand by in a stopped state without selecting an inspection facility from the plurality of inspection facilities when the plurality of inspection facilities are unavailable.

8. The inspection logistics system of claim 1, wherein
the weight determination unit imposes a weight based on a number of carriers existing between the search start point and the reachable inspection facility.

9. The inspection logistics system of claim 1, wherein
the weight determination unit imposes a weight based on a remaining inspection time of the inspection object when there is an inspection object being inspected in the plurality of inspection facilities.

10. The inspection logistics system of claim 1, wherein
the weight determination unit terminates a weight calculation when a carrier has stopped between the search staring point and the reachable inspection facility, when a number of carriers moving from the search starting point to the reachable inspection facility and the number of carriers present in the reachable inspection facilities exceeds a specified range, or when the reachable inspection facility is inoperable.

11. An inspection logistics optimization scheduling method, comprising:
updating a status of a plurality of inspection facilities;
searching for nodes composed of connections between a plurality of coils that move an inspection object placed on a carrier to the plurality of inspection facilities and updating information obtained between a search start point and a reachable inspection facility; and
selecting an inspection facility to which the carrier will move based on an updated facility status and updated information.

12. The inspection logistics optimization scheduling method of claim 11, wherein
the updating of the status of the plurality of inspection facilities includes updating an operation status of the plurality of inspection facilities, and a remaining inspection process time when an inspection object is disposed in the plurality of inspection facilities.

13. The inspection logistics optimization scheduling method of claim 11, wherein
the updating of the information includes determining a status and quantity of all carriers disposed between the search start point and the reachable inspection facility, and calculating a movement weight between the nodes.

14. The inspection logistics optimization scheduling method of claim 13, wherein
the updating of the information includes configuring a relationship between the plurality of coils as nodes, configuring a relationship between nodes as a node list, and searching an entire section through recursive search.

15. The inspection logistics optimization scheduling method of claim 14, wherein
the updating of the information further includes checking a carrier status of a starting node in the node list, obtaining a child node list of the starting node, checking a carrier status of a selected node selected in the child node list, and obtaining a child node list of the selected node.

16. The inspection logistics optimization scheduling method of claim 11, comprising:
skipping searching for nodes when there is no inspection object disposed on the carrier or when an inspection process of the inspection object is completed.

17. The inspection logistics optimization scheduling method of claim 11, comprising:
causing the carrier to stand by in a stopped state without selecting an inspection facility when an inspection facility of the plurality of inspection facilities are unavailable.

18. The inspection logistics optimization scheduling method of claim 11, wherein
the selecting of the inspection facility includes imposing a weight based on a number of carriers disposed between the search start point and the reachable inspection facility.

19. The inspection logistics optimization scheduling method of claim 11, wherein
the selecting of the inspection facility includes imposing a weight based on a remaining inspection time of the inspection object when there is an inspection object being inspected in the plurality of inspection facilities.

20. The inspection logistics optimization scheduling method of claim 11, comprising:
terminating a weighting calculation when the carrier has stopped between the search starting point and the reachable inspection facility, when a number of carriers moving from the search starting point to the reachable inspection facility and the number of carriers disposed in the reachable inspection facility exceed a specified range, or when the reachable inspection facility is inoperable.
